(19) United States
(12) Patent Application Publication
(10) Pub. No.: US 2003/0140002 A1
(43) Pub. Date: Jul. 24, 2003

(54) Bank

(76) Inventor: Shan-Hui Chiang, Taoyuan (TW)

Correspondence Address: RABIN & BERDO, P.C., Suite 500, 1101 14th STREET, N.W., Washington, DC, 20005, US

(21) Appl. No.: 10/053,568

(22) Filed: Jan. 24, 2002

(51) Int. Cl. G06F 17/60

(52) U.S. Cl. 705/39

(57) ABSTRACT

A bank is constructed to include a bank body defining a number of storage compartments, a top cover covering the bank body, the top cover having a plurality of coin slots of different sizes respectively disposed in communication with the storage compartments of the bank body, and an electric circuit assembly installed in the top cover and adapted to detect the value and number of coins inserted into the coin slots and to display the value of individual coin inserted through the coin slots and the sum of coins received in the bank body.

### BACKGROUND OF THE INVENTION

1. Field of the Invention

The present invention relates to a bank and, more particularly, to such a bank, which comprises an electric circuit assembly that detects the value and number of coins currently inserted and displays the value of individual coin currently inserted and the sum of total coins received.

2. Description of the Related Art

FIG. 7 illustrates a bank constructed according to the prior art. This structure of bank comprises a bank body A defining a storage chamber, and a coin slot A1 in the peripheral wall of the bank body A through which coins are inserted into the storage chamber in the bank body A. The bank body A has a particular design to attract children. When wishing to take storage coins away from the bank, the user shall have to break the bank body A. FIG. 8 shows another structure of bank according to the prior art. According to this design the bank has a coin outlet A2 in the bottom sidewall of the bank body A, and a seal B adapted to seal the coin outlet A2. After removal of the seal B from the coin outlet A2, the user can easily take away storage coins from the bank body A. The aforesaid two different banks have only one single coin slot and one single coin storage compartment for keeping coins of different values. Further, the user cannot know how much the coins currently kept in the bank.

### SUMMARY OF THE INVENTION

The present invention has been accomplished under the circumstances in view. It is one object of the present invention to provide a bank, which displays the value of the coin currently inserted therein and the sum of total coins received. It is another object of the present invention to provide a bank, which keeps inserted coins classified. It is still another object of the present invention to provide a bank, which provides a clock mode for option. To achieve these and other objects of the present invention, the bank comprises a bank body defining a number of storage compartments, a top cover covering the bank body, the top cover having a plurality of coin slots of different sizes respectively disposed in communication with the storage compartments of the bank body, and an electric circuit assembly installed in the top cover and adapted to detect the value and number of coins inserted into the coin slots and to display the value of individual coin inserted through the coin slots and the sum of coins received in the bank body. Furthermore, the electric circuit assembly has a selector button adapted to select between a clock mode and an amount counting mode.

### BRIEF DESCRIPTION OF THE DRAWINGS

FIG. 1 is an exploded view of a bank constructed according to the present invention.

FIG. 2 is an elevational view of the bank according to the present invention.

FIG. 3 is a side view in section of the bank according to the present invention.

FIG. 4 is a schematic sectional view showing the operation of the present invention (I).

FIG. 5 is a schematic sectional view showing the operation of the present invention (II).

FIG. 6 is a schematic sectional view showing the operation of the present invention (III).

FIG. 7 is an elevational view of a bank constructed according to the prior art.

FIG. 8 is a perspective exploded view of another structure of bank constructed according to the prior art.

### DETAILED DESCRIPTION OF THE PREFERRED EMBODIMENT

Referring to FIGS. from 1 through 3, a bank in accordance with the present invention comprises a top cover 1, an electric circuit assembly 2, and a bank body 3.

The top cover 1 comprises a plurality of coin slots 11 of different sizes for the insertion of coins of different values, a plurality of coin passageways 111 respectively downwardly extended from the coin slots 11, a box 12 vertically disposed near the periphery, a partition board 13 separating the box 12 from the coin slots 11 and defining a receiving chamber 14 in the box 12, a plurality of sensor holes 131 extended through the partition board 13 corresponding to the coin slots 11, a first locating plate 141 horizontally suspended in the receiving chamber 14 at one side remote from the coin slots 11, a vertical plate 142 downwardly extended from the top sidewall of the receiving chamber 14, a second locating plate 1421 perpendicularly extended from the vertical plate 142 and aimed at the first locating plate 141, a transparent plate 15 covering an opening 121 in one side of the box 12 above the elevation of the coin slots 11, two button holes 122 disposed at one side of the transparent plate 15, and a bottom coupling portion 16.

The electric circuit assembly 2 comprises a control circuit board 21, a plurality of sensors 22 respectively soldered to the control circuit board 21, and a display 23 electrically connected to the control circuit board 21. The display 23 comprises a display screen 231, a reset button 232, and a selector button 233.

The bank body 3 has a top-open holding space 31, and a plurality of partition plates 32 fixedly mounted in the top-open holding space 31 and separating the top-open holding space 31 into a plurality of storage compartments 33 corresponding to the coin passageways 111.

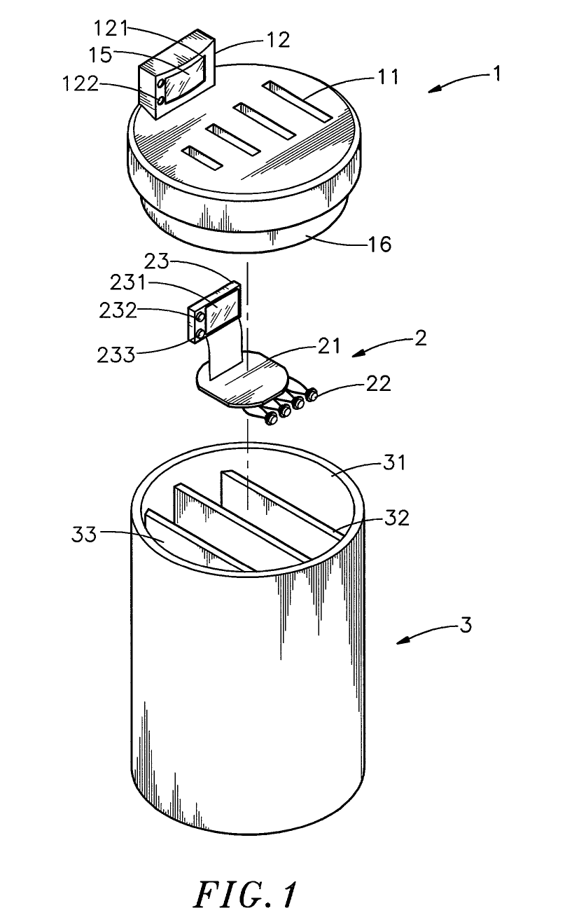

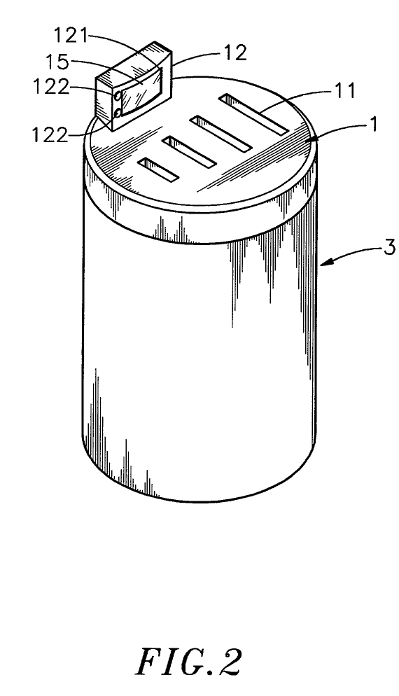

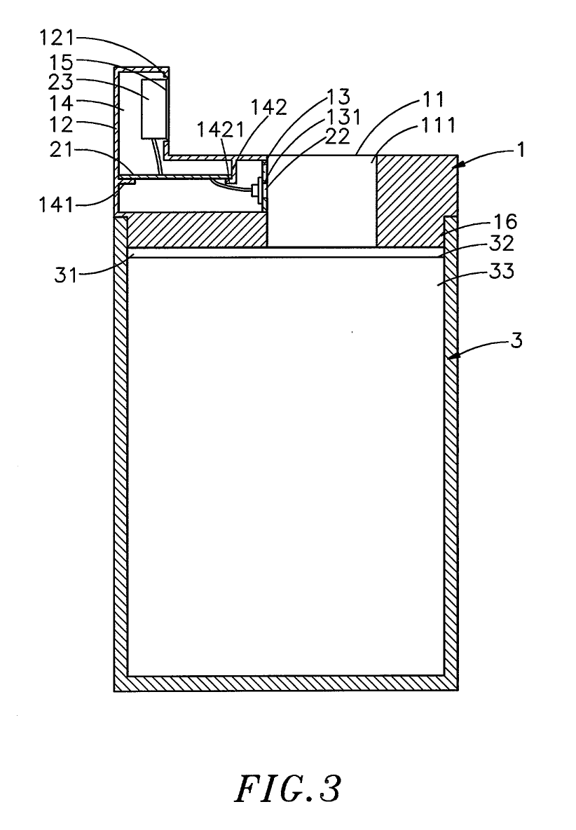

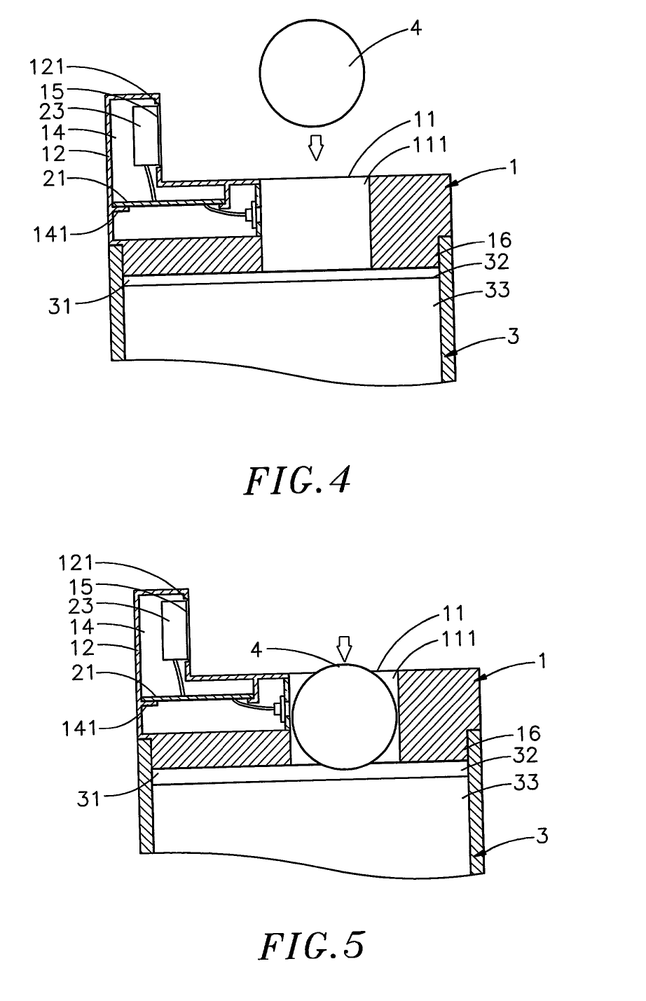

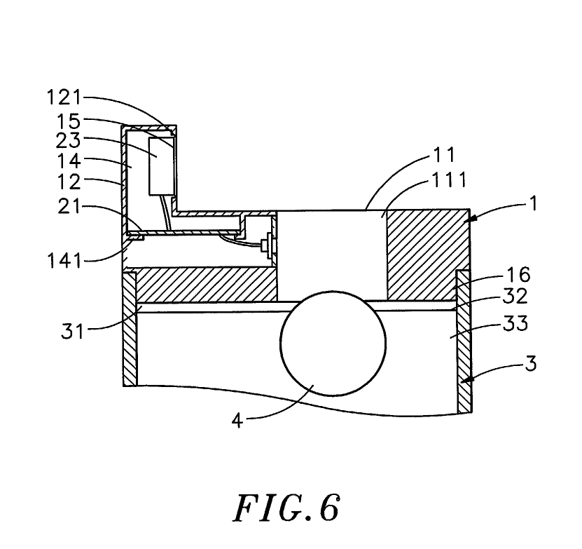

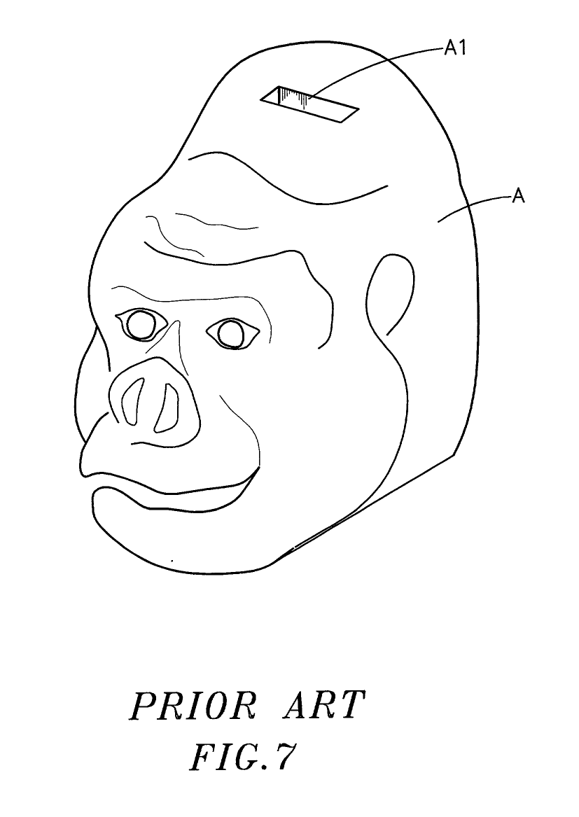

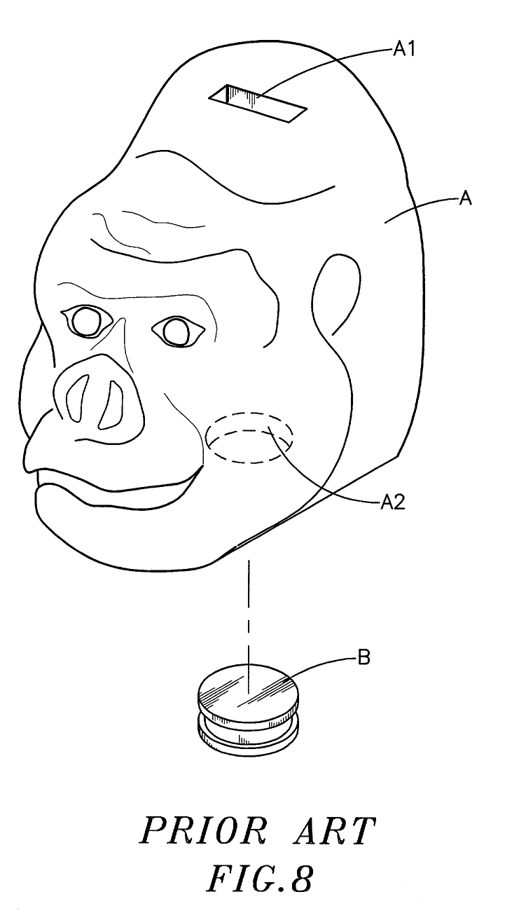

The assembly process of the present invention is outlined hereinafter with reference to FIGS. 1 and 3 again. The electric circuit assembly 2 is inserted into the receiving chamber 14 from the bottom side of the top cover 1, and then the control circuit board 21 is fixedly mounted on the first locating plate 141 and the second locating plate 1421, keeping the display screen 231 of the display 23 in close contact with the inner surface of the transparent plate 15, the buttons 232 and 233 of the display 23 and the sensors 22 respectively engaged into the button holes 122 and the sensor holes 131 of the partition board 13, and then the bottom coupling portion 16 is press-fitted into the top-open holding space 31 of the bank body 3 from the top, keeping the coin passageways 111 in communication with the storage compartments 33 respectively.

Referring to FIGS. from 4 through 6 and FIGS. 1 and 3 again, when in use, coins of different values are respectively inserted into the coin slots 11. Inserted coins pass through the respective coin passageways 111 to the respective storage compartments 33. When a coin passed from one coin passageway 111 to the corresponding storage compartment 33 of the bank body 3, the corresponding sensor 22 is induced to produce a signal to the control circuit board 21, thereby causing the control circuit board 21 to drive the display 23 to display on the display screen 231 the value of the inserted coin and the sum of total coins received. A voice broadcasting system may be provided to broadcast the value of the coin currently inserted and the sum of total coins received. By means of operating the selector switch 233, the display screen 231 of the display 23 is switched between clock mode and amount counting mode. After removal of accumulated coins from the bank body 3, the reset button 232 is switched to zero the display of the display 23.

A prototype of bank has been constructed with the features of the annexed drawings of FIGS. 1˜6. The bank functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bank comprising a bank body, said bank body comprising a top-open holding space defining at least one storage compartment, and a top cover covering said bank body, said top cover comprising at lest one coin slot and at least one coin passageway respectively downwardly extended from said at least one coin slot and respectively disposed in communication with said at least one storage compartment of said bank body, wherein an electric circuit assembly is installed in said top cover, said electric circuit assembly comprising a control circuit board, at least one sensor electrically connected to said control circuit board and respectively aimed at said at least one coin passageway and adapted to detect the value and number of coins passing through said at least one coin passageway, and display means electrically connected to said control circuit board and adapted to display the value of individual coin inserted through said at least one coin slot and the sum of coins received in said bank body.

2. The bank as claimed in claim 1, wherein said top cover comprises a bottom coupling portion press-fitted into a top-open holding space of said bank body.

3. The bank as claimed in claim 1, wherein the at least one coin slot of said top cover includes a plurality of coin slots of different sizes for the insertion of coins of different values, and said at least one coin passageway includes a plurality of coin passageways respectively downwardly extended from said coin slots of different sizes.

4. The bank as claimed in claim 3, wherein said bank body comprises a plurality of partition plates separating said top-open holding space into a plurality of storage compartments respectively disposed in communication with said coin passageways.

5. The bank as claimed in claim 1, wherein said at least one sensor of said electric circuit assembly is respectively soldered to said control circuit board.

6. The bank as claimed in claim 1, wherein said display means comprises a reset button for reset control, and a selector button for operation mode selection control.

7. The bank as claimed in claim 1, wherein said electric circuit assembly further comprises a voice broadcasting system adapted to broadcast the value of the coin currently inserted through said at least one coin slot and the sum of total coins received in said bank body.

8. The bank as claimed in claim 6, wherein said selector button is adapted to select between a clock mode and an amount counting mode.
